(19) United States
(12) Patent Application Publication
(10) Pub. No.: US 2006/0114266 A1
(43) Pub. Date: Jun. 1, 2006

(54) Processor and Related Method for Adjusting Color Attributes

(76) Inventors: Tsorng-Yang Mei, Taipei City (TW); Chia-Lei Yu, Taipei City (TW); Hsu-Huang Cheng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/162,793

(22) Filed: Sep. 23, 2005

(30) Foreign Application Priority Data
Dec. 1, 2004 (TW) 093137064

(51) Int. Cl. G09G 5/02

(52) U.S. Cl. 345/604

(57) ABSTRACT

A processor and a related method for adjusting color attributes of pixels are introduced. The method of the present invention includes transforming the color attributes of a first format having no independent luminance signal to color attributes of a second format having an independent luminance signal, and adjusting the color attributes of the second format such that the luminance signal can be processed individually and directly. The processor of the present invention includes an examining unit for examining color attributes of pixels, a transforming unit coupled to the examining unit for transforming the color attributes of pixels of a first format to a second format that comprises an independent luminance signal, an adjusting unit coupled to the transforming unit for adjusting color attributes of pixels, and an inverse-transforming unit coupled to the adjusting unit for transforming the color attributes of pixels of the second format to the first format.

### BACKGROUND OF THE INVENTION

1. Field of the Invention

The present invention relates to a processor and a related method for adjusting color attributes of a pixel; and more particularly, to a processor and a related method for adjusting color attributes of a pixel by transforming the color attributes of the pixel from a set of color attributes of a first format without an independent luminance signal to a set of color attributes of a second format with a luminance signal and a color signal, and then adjusting the set of color attributes of the second format.

2. Description of the Prior Art

In the field of displaying, it is important to adjust color attributes of pixels. The color may be distorted due to the limitations of transmission bandwidth, or the image may need to be adjusted due to users' preferences as well. For both of the aforementioned cases, the color attributes need to be processed for improving the display performance. Some examples of common improvements of display performance are human flesh-tone correction, green enhancement, and blue stretch. Generally, a format of color attributes that includes components of red, green and blue is adopted for representing the color of a pixel, which is known as an RGB format. However, the property of luminance is dispersed in the three values of the elements R, G and B (representing red, green and blue, respectively). Therefore, only the hues and saturations of the elements R, G and B can be adjusted, while the property of luminance, an important factor in human vision, cannot be processed and adjusted directly.

### SUMMARY OF THE INVENTION

It is therefore a primary objective of the claimed invention to provide a processor and a related method for adjusting color attributes of a pixel by transforming the color attributes of the pixel from a set of color attributes of a first format without an independent luminance signal to a set of color attributes of a second format with a luminance signal and a color signal, and adjusting the luminance signal and the color signal separately.

Briefly described, the claimed invention discloses a method for adjusting color attributes of pixels. The method includes examining color attributes of a pixel in order to obtain a first set of color attributes of a first format; transforming the first set of color attributes of the first format to a first set of color attributes of a second format when the first set of color attributes of the first format conforms to a predetermined range, wherein the first set of color attributes of the second format comprises a first luminance signal and a first color signal; adjusting the first set of color attributes of the second format to a second set of color attributes of the second format, wherein the second set of color attributes of the second format comprises a second luminance signal and a second color signal; and transforming the second set of color attributes of the second format to a second set of color attributes of the first format, and setting the second set of color attributes of the first format as the color attributes of the pixel.

The claimed invention further discloses a processor for adjusting color attributes of pixels. The processor includes an examining unit, a transforming unit coupled to the examining unit, an adjusting unit coupled to the transforming unit, and an inverse-transforming unit coupled to the adjusting unit. The examining unit is for examining whether color attributes of a pixel conform to a predetermined range. The transforming unit is for transforming the color attributes of a first format of the pixel to a first set of color attributes of a second format when the color attributes of the first format of the pixel conform to the predetermined range, wherein the first set of color attributes of the second format comprises a luminance signal and a color signal. The adjusting unit is for adjusting the first set of color attributes of the second format to a second set of color attributes of the second format, and the inverse-transforming unit is for transforming the second set of color attributes of the second format to a set of color attributes of the first format.

It is an advantage of the present invention that the format of the color attributes of the pixel to be adjusted is transformed to another format of color attributes with a luminance signal and a color signal, such that the brightness of the pixel can be adjusted independently and effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of the method for adjusting color attributes of the present invention.

FIG. 2 is a block diagram of a first embodiment of the processor for adjusting color attributes of pixels of the present invention.

FIG. 3 is a block diagram of a second embodiment of the processor for adjusting color attributes of pixels of the present invention.

### DETAILED DESCRIPTION

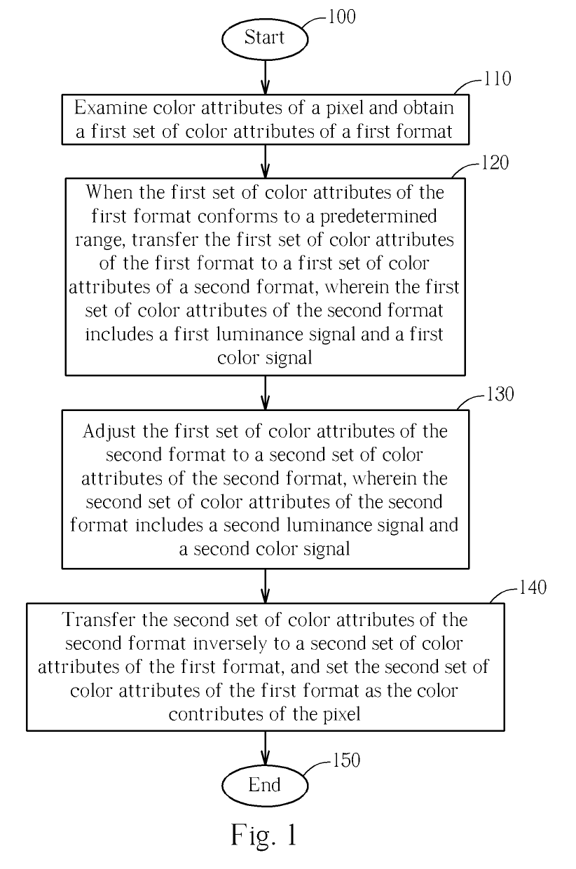

In the present invention, when color attributes of a pixel are examined to conform to a predetermined range, the luminance of the color attributes of the pixel is extracted for processing. That is, the present invention processor transforms the format of color attributes of the pixel from a first format which does not include an independent luminance signal to a second format which includes a luminance signal and a color signal, and then adjusts the luminance signal or the color signal depending on the need. Please refer to FIG. 1. FIG. 1 is a flowchart of the method for adjusting color attributes of the present invention. The predetermined range of color attributes to be adjusted may, for example, be the range of human flesh-tone when human flesh-tone correction is planned to be performed, or may be the range of green plants when the green enhancement is planned to be performed.

Step 100: Start;

Step 110: Examine color attributes of a pixel and obtain a first set of color attributes of a first format;

Step 120: When the first set of color attributes of the first format conforms to a predetermined range, transform the first set of color attributes of the first format to a first set of color attributes of a second format, wherein the first set of color attributes of the second format includes a first luminance signal and a first color signal;

Step 130: Adjust the first set of color attributes of the second format to a second set of color attributes of the second format, wherein the second set of color attributes of the second format includes a second luminance signal and a second color signal;

Step 140: Transform the second set of color attributes of the second format inversely to a second set of color attributes of the first format, and set the second set of color attributes of the first format as the color attributes of the pixel;

Step 150: End.

Assume the adopted format of color attributes is the RGB format. The present invention processor can utilize a transforming matrix T shown below to transform the color attributes of the RGB format to the color attributes of the YUV format which include a luminance signal and a color signal. Note that in the YUV format of color attributes, the element Y stands for the luminance signal, and the elements U and V stand for color signals:

$$T = [ \begin{matrix}a 1 & a 2 & a 3 \\ b 1 & b 2 & b 3 \\ c 1 & c 2 & c 3\end{matrix} ] ;$$

wherein a1, a2 and a3 are coefficients relative to the element Y of the elements R, G and B respectively; b1, b2 and b3 are coefficients relative to the element U of the elements R, G and B respectively; and c1, c2 and c3 are coefficients relative to the element V of the elements R, G and B respectively.

Assume the color adjustment system is set to perform human flesh-tone correction, and it is the luminance which is to be adjusted. For example, when a pixel is examined in Step 110 and the color attributes of the RGB format of the pixel, [R1, G1, B1], are determined to conform to the predetermined range of human flesh-tone color, it is determined that the pixel represents human flesh-tone and needs to be adjusted. Assume the adjusting rule is to increase the lightness of color blocks of human flesh-tone. Therefore, Step 120 transforms the color attributes of the RGB format of the pixel to the color attributes of the YUV format which includes a luminance signal and a color signal:

$$[ \begin{matrix}Y 1 \\ U 1 \\ V 1\end{matrix} ] = T \cdot [ \begin{matrix}R 1 \\ G 1 \\ B 1\end{matrix} ] ;$$

wherein the element Y1 is the luminance signal extracted from the luminance part of the three elements of the color attributes of the RGB format [R1, G1, B1], and the elements U1 and V1 are the chrominance signals extracted from the color attributes of the RGB format [R1, G1, B1].

In Step 130, the color attributes of the YUV format [Y1, U1, V1] are adjusted according to the predetermined rule, that is, to increase the lightness of the pixel. For example, the value of the luminance signal can be increased by a fixed amount. Therefore, the adjusted color attributes of the YUV format are as below, represented by [Y1′, U1′, V1′]:
[Y1′, U1′, V1′]=[Y1+ΔY, U1, V1]

In Step 140, the inverse matrix of the transforming matrix T, represented by T⁻¹, inversely transforms the adjusted color attributes of the YUV format [Y1′, U1′, V1′] to the RGB format [R1′, G1′, B1′]. The color attributes of the RGB format [R1′, G1′, B1′] are set as the updated color attributes of the pixel:

$$[ \begin{matrix}R {1}^{′} \\ G {1}^{′} \\ B {1}^{′}\end{matrix} ] = {T}^{- 1} \cdot [ \begin{matrix}Y {1}^{′} \\ U {1}^{′} \\ V {1}^{′}\end{matrix} ]$$

In the above embodiment of the present invention, the rule for adjusting the color attributes of the YUV format can be designed variously depending on the demand. For instance, besides being increased by a fixed amount ΔY, the value of the luminance signal can be increased by a fixed ratio, such as Y′=Y×(1+m %). The chrominance signals can be adjusted according to similar rules as well. The present invention may adopt the [Y, Cb, Cr] format of color attributes and corresponding transforming matrix as well as the [Y, U, V] format of color attributes.

The method of the present invention may further include allowing users to cancel or reject the automatic adjustment. When color attributes of a pixel that conforms to a predetermined range of color attributes are adjusted according to a predetermined rule, users may send a cancel instruction to cancel the adjustment and recover the original color attributes of the pixel. For example, when receiving a cancel instruction, the adjusted color attributes of the RGB format [R1′, G1′, B1′] are transformed inversely to the color attributes of the YUV format:

$$[ \begin{matrix}Y {1}^{′} \\ U {1}^{′} \\ V {1}^{′}\end{matrix} ] = T \cdot [ \begin{matrix}R {1}^{′} \\ G {1}^{′} \\ B {1}^{′}\end{matrix} ] ;$$

Then the adjusted color attributes of the YUV format [Y1′, U1′, V1′] can be adjusted backto the original color attributes since the adjustment procedure is known. Assume the adjustment rule is increasing the value of the luminance signal by a fixed amount. Therefore the color attributes can be adjusted back by decreasing the value of the luminance signal by the same fixed amount:
[Y1″, U1″, V1″]=[Y1′−ΔY, U1, V1]=[Y1, U1, V1];
Then the recovered color attributes of the YUV format [Y1″, U1″, V1″] i.e., the original color attributes of the YUV format [Y1, U1, V1], can be transformed to the color attributes of the RGB format by the inverse matrix of the transforming matrix T:

$$[ \begin{matrix}R {1}^{″} \\ G {1}^{″} \\ B {1}^{″}\end{matrix} ] = {T}^{- 1} \cdot [ \begin{matrix}Y {1}^{″} \\ U {1}^{″} \\ V {1}^{″}\end{matrix} ] = {T}^{- 1} \cdot [ \begin{matrix}Y 1 \\ U 1 \\ V 1\end{matrix} ] = [ \begin{matrix}R 1 \\ G 1 \\ B 1\end{matrix} ] ;$$

Accordingly, the original setting of color attributes of the pixel is recovered.

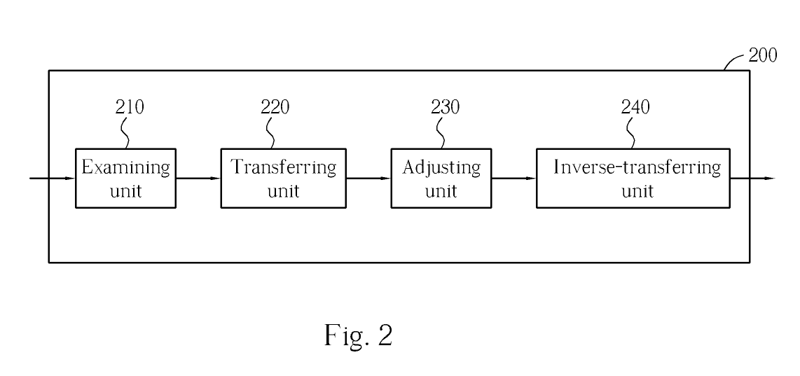

The method for adjusting color attributes of the present invention can be implemented by a processor. Please refer to FIG. 2. FIG. 2 is a block diagram of a first embodiment of a processor for adjusting color attributes of pixels of the present invention. The processor 200 includes an examining unit 210, a transforming unit 220 coupled to the examining unit 210, an adjusting unit 230 coupled to the transforming unit 220, and an inverse-transforming unit 240 coupled to the adjusting unit 230. The examining unit 210 is utilized to examine whether color attributes of a first format of a pixel conform to a predetermined range, wherein the first format of color attributes does not include an independent luminance signal. The transforming unit 220 is capable of transforming the color attributes of the first format of the pixel conforming to the predetermined range to a first set of color attributes of a second format according to a predetermined rule, wherein the second format of color attributes includes a luminance signal and a color signal. The adjusting unit 230 is utilized to adjust the first set of color attributes of the second format to a second set of color attributes of the second format, that is, to perform Step 130 as illustrated in FIG. 1. The inverse-transforming unit 240 is capable of transforming the second set of color attributes of the second format to a corresponding set of color attributes of the first format, and to assign the corresponding set of color attributes of the first format as the updated color attributes of the pixel.

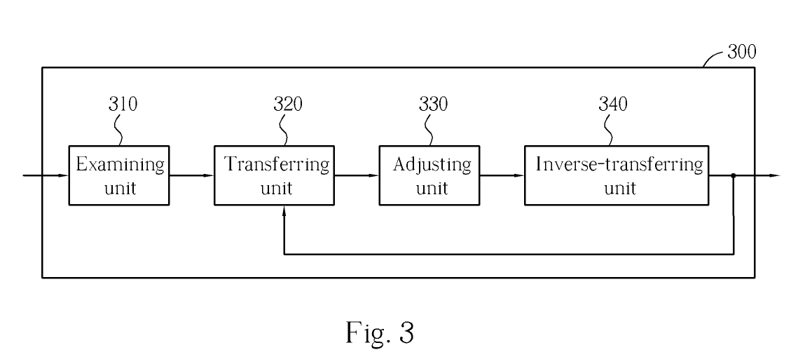

Please refer to FIG. 3. FIG. 3 is a block diagram of the second embodiment of the processor for adjusting color attributes of pixels of the present invention. The processor 300 includes an examining unit 310, a transforming unit 320 coupled to the examining unit 310, an adjusting unit 330 coupled to the transforming unit 320, and an inverse-transforming unit 340 coupled to the adjusting unit 330 and the transforming unit 320. Besides the adjusting function of the processor 200 illustrated in FIG. 2, the processor 300 in FIG. 3 is further capable of recovering the settings of color attributes of the pixel when receiving a cancel instruction. The second set of color attributes of the first format output by the inverse-transforming unit 340 is input to the transforming unit 320 to revert the second set of color attributes of the first format to the first set of color attributes of the first format. That is, the transforming unit 320 transforms the second set of color attributes of the first format to the second set of color attributes of the second format, the adjusting unit 330 adjusts the second set of color attributes of the second format back to the first set of color attributes of the second format, and the recovered first set of color attributes of the second format is input to the inverse-transforming unit 340 in order to transform to the first set of color attributes of the first format, i.e., the original color attributes. Therefore the present invention successfully gives users the option to cancel or reject the predetermined adjustment of color attributes.

In summary, the present invention provides a processor and related methods for adjusting color attributes of pixels by transforming the color attributes of the pixel from a set of color attributes of a first format without an independent luminance signal to a set of color attributes of a second format with a luminance signal and a color signal, and adjusting the luminance signal and the color signal of the second format separately. The performance of the color adjustment of displays is improved accordingly. The embodiments of the present invention are provided to illustrate the flow of determining and adjusting. An option of canceling the adjustment of color attributes is provided to users by the claimed invention to reject erroneous adjustment. The range of color attributes to be adjusted, the determining rule and adjusting rule can be fixed or set by the user. The processor and methods for adjusting color attributes of the claimed invention can be applied to correct human flesh-tones, adjusting lightness of a sky area, or for other specific adjustments depending on demands.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting color attributes of pixels comprising:
examining color attributes of a pixel and obtaining a first set of color attributes of a first format;
transforming the first set of color attributes of the first format to a first set of color attributes of a second format when the first set of color attributes of the first format conforms to a predetermined range, wherein the first set of color attributes of the second format comprises a first luminance signal and a first color signal;
adjusting the first set of color attributes of the second format to a second set of color attributes of the second format, wherein the second set of color attributes of the second format comprises a second luminance signal and a second color signal; and
transforming the second set of color attributes of the second format to a second set of color attributes of the first format, and setting the second set of color attributes of the first format as the color attributes of the pixel.

2. The method of claim 1 further comprising:
setting the first set of color attributes of the first format as the color attributes of the pixel according to a cancel instruction.

3. The method of claim 2 further comprising:
transforming the second set of color attributes of the first format to the second set of color attributes of the second format according to the cancel instruction;
adjusting the second set of color attributes of the second format back to the first set of color attributes of the second format; and
transforming the first set of color attributes of the second format to the first set of color attributes of the first format, and setting the first set of color attributes of the first format as the color attributes of the pixel.

4. The method of claim 1 wherein the color signal comprises a set of chrominance signals.

5. A processor for adjusting color attributes of pixels comprising:
an examining unit for examining whether color attributes of a pixel conform to a predetermined range;
a transforming unit coupled to the examining unit, the transforming unit being for transforming the set of color attributes of a first format of the pixel to a first set of color attributes of a second format when the color attributes of the first format of the pixel conform to the predetermined range, wherein the first set of color attributes of the second format comprises a luminance signal and a color signal;
an adjusting unit coupled to the transforming unit, the adjusting unit being for adjusting the first set of color attributes of the second format to a second set of color attributes of the second format; and
an inverse-transforming unit coupled to the adjusting unit, the inverse-transforming unit being for transforming the second set of color attributes of the second format to a set of color attributes of the first format.

6. The processor of claim 5 wherein the adjusting unit is for adjusting the luminance signal and the color signal of color attributes of the second format.

7. The processor of claim 5 wherein the color signal comprises a set of chrominance signals.

8. The processor of claim 5 wherein the transforming unit is further for transforming a set of color attributes of the first format generated by the inverse-transforming unit to a set of color attributes of the second format according to a cancel instruction, and the adjusting unit is further for adjusting color attributes of the set of color attributes of the second format generated by the transforming unit according to the cancel instruction.
